(19) United States
(12) Patent Application Publication
(10) Pub. No.: US 2025/0064020 A1
(43) Pub. Date: Feb. 27, 2025

(54) ROLLING GAME FEED DISPENSER ASSEMBLY

(71) Applicant: James Grant, Longview, TX (US)

(72) Inventor: James Grant, Longview, TX (US)

(21) Appl. No.: 18/237,985

(22) Filed: Aug. 25, 2023

(51) Int. Cl. A01M 31/00; A01K 5/02

(52) U.S. Cl. CPC A01K 15/025; A01M 31/008; A01K 5/0233

(57) ABSTRACT

A game feeder assembly for feeding game animals on a game trail includes a feed container for containing a granular animal feed. The feed container is continuously arcuate about a center line of the feed container to facilitate the feed container to be rolled along the ground by an animal. The feed container has a plurality of feed holes to release the granular animal feed when the feed container is rolled along the ground thereby enticing the animal to remain with the feed container. A lid is removably attachable to 10 the feed container for closing the feed container and retaining the granular animal feed in the feed container.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) FIELD OF THE INVENTION

The disclosure relates to feeder devices and more particularly pertains to a new feeder device for feeding game animals on a game trail. The device includes a feed container for containing a granular animal feed and which has a cylindrical shape to facilitate the feed container to be rolled along the ground by a game animal. The feed container has feed openings for dispensing the granular animal feed when the game animal rolls the feed container.

### (2) DESCRIPTION OF RELATED ART INCLUDING INFORMATION DISCLOSED UNDER 37 CFR 1.97 AND 1.98

The prior art relates to feeder devices including a variety of spherical pet toy devices that have foraminous elements, a treat dispenser that includes a pair of disks extending around a cylinder which each has a unique diameter with respect to each other and a pet food dispenser that includes a jar with perforations and a rope that is knotted in a neck of the jar with a loop that is positioned outside of the jar. In no instance does the prior art disclose an animal feed dispenser that has a cylindrical shape to be rolled on the ground by a game animal and feed openings for releasing granular animal feed when the animal feed dispenser is rolled.

### (h) BRIEF SUMMARY OF THE INVENTION

An embodiment of the disclosure meets the needs presented above by generally comprising a feed container for containing a granular animal feed. The feed container is continuously arcuate about a center line of the feed container to facilitate the feed container to be rolled along the ground by an animal. The feed container has a plurality of feed holes to release the granular animal feed when the feed container is rolled along the ground thereby enticing the animal to remain with the feed container. A lid is removably attachable to the feed container for closing the feed container and retaining the granular animal feed in the feed container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a game feeder assembly according to an embodiment of the disclosure.

FIG. 2 is an exploded perspective view of an embodiment of the disclosure.

FIG. 3 is a front exploded view of an embodiment of the disclosure.

FIG. 4 is a perspective view of an alternative embodiment of the disclosure.

FIG. 5 is a perspective in-use view of an embodiment of the disclosure showing a feed container being kicked by a game animal.

FIG. 6 is a perspective in-use view of an embodiment of the disclosure showing a feed container being rolled by a game animal.

### (j) DETAILED DESCRIPTION OF THE INVENTION

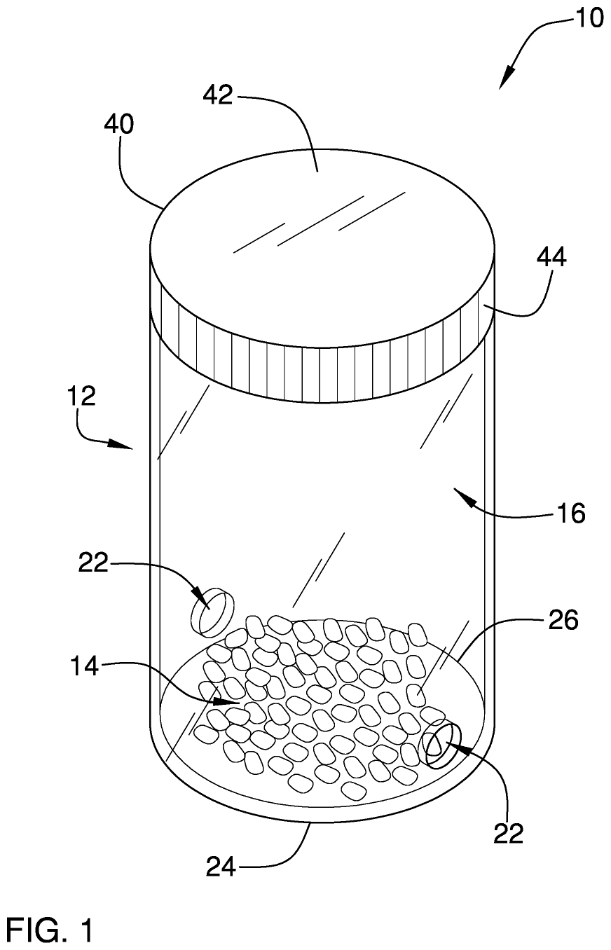

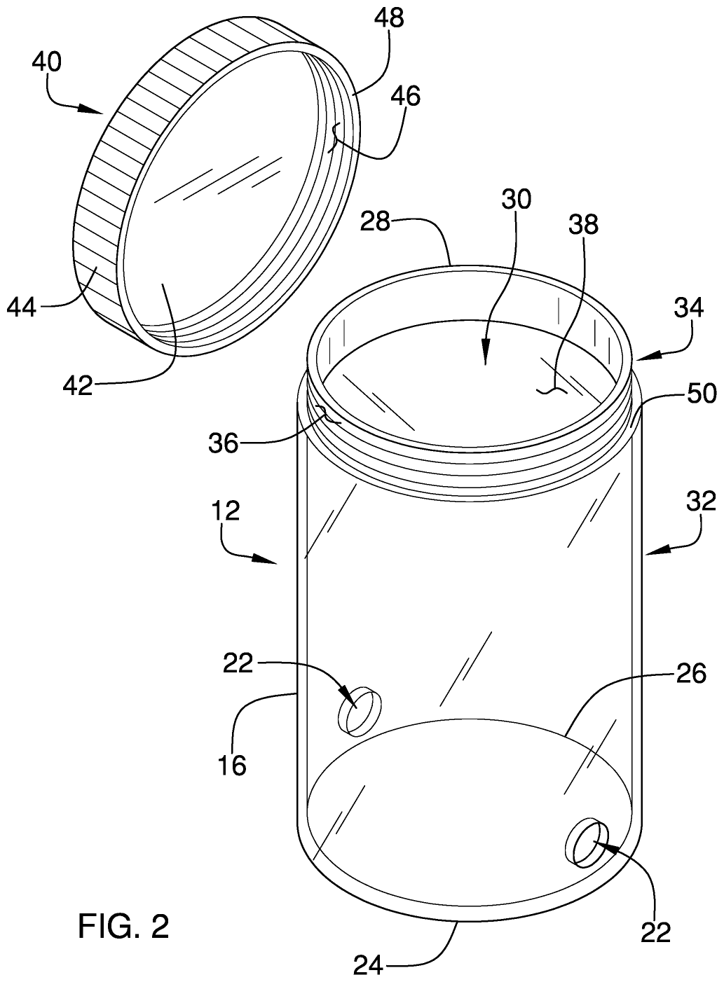

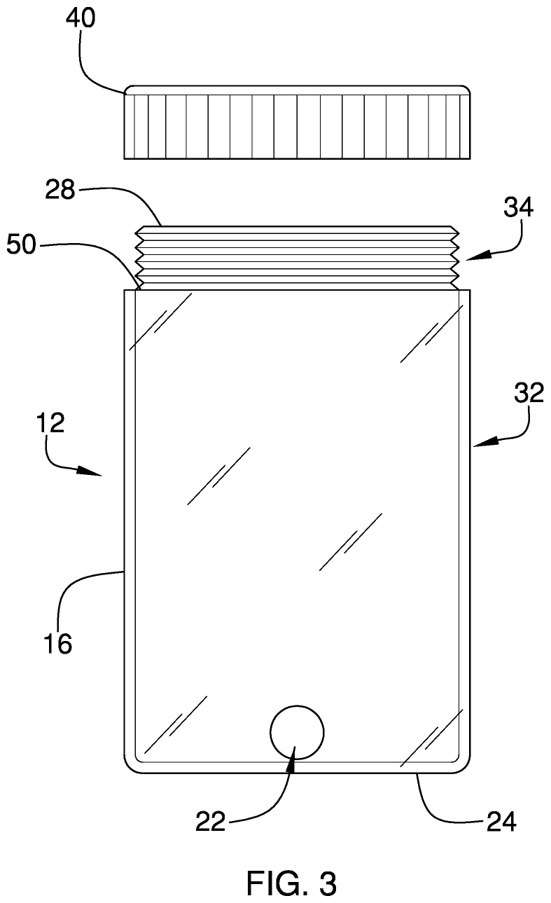

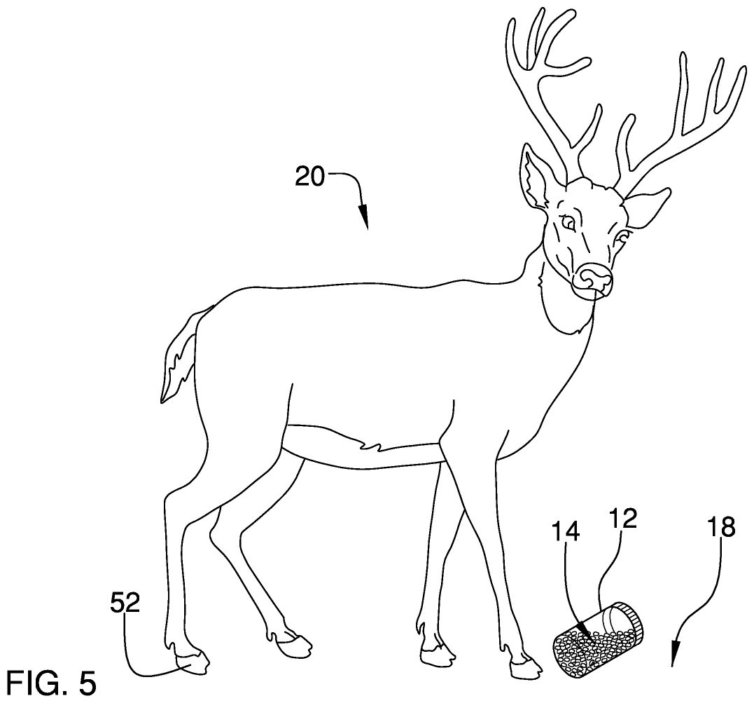

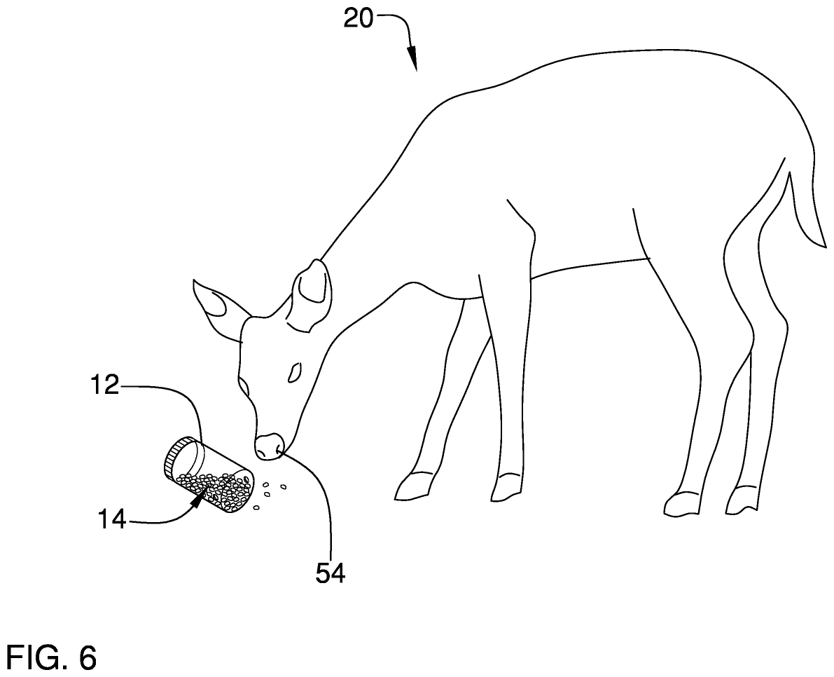

With reference now to the drawings, and in particular to FIGS. 1 through 6 thereof, a new feeder device embodying the principles and concepts of an embodiment of the disclosure and generally designated by the reference numeral 10 will be described.

As best illustrated in FIGS. 1 through 6, the game feeder assembly 10 generally comprises a feed container 12 for containing a granular animal feed 14. The granular animal feed 14 may be corn, grains or any other type of granular feed that is typically employed for attracting deer and other type of game animals for hunting. The feed container 12 has an outer wall 16 that is continuously arcuate about a center line of the feed container 12. In this way the feed container 12 can be rolled along the ground 18 by a game animal 20, such as a deer for example. The feed container 12 has a plurality of feed holes 22 each extending through the outer wall 16 thereby facilitating each of the feed holes 22 to release the granular animal feed 14 through the plurality of feed holes 22. In this way the plurality of feed holes 22 can release the granular animal feed 14 when the feed container 12 is rolled along the ground 18 thereby enticing the game animal 20 to remain with the feed container 12. The feed container 12 may be comprised of a translucent and shatter resistant material, including but not being limited to polycarbonate, thereby facilitating the granular animal feed 14 to be visible through the feed container 12 as well as facilitating the feed container 12 to resist being shattered while the feed container 12 is rolled along the ground 18.

The feed container 12 has a lateral wall 24 and the outer wall 16 extends away from a perimeter edge 26 of the lateral wall 24. The outer wall 16 is continuously arcuate about a center point of the lateral wall 24 such that the feed container 12 has a cylindrical shape. In this way the feed container 12 rolls on the ground 18 about an axis extending between the lateral wall 24 and a distal edge 28 of the outer wall 16. The distal edge 28 of the outer wall 16 defines an entrance 30 into the feed container 12 for filling the feed container 12 with the granular animal feed 14. The outer wall 16 has a first portion 32 which intersects the lateral wall 24 and a second portion 34 that is inset with respect to the first portion 32. The second portion 34 is associated with the distal edge 28 such that the entrance 30 defined by the distal edge 28 has a diameter that is less than a diameter defined by the first portion 32 of the outer wall 16.

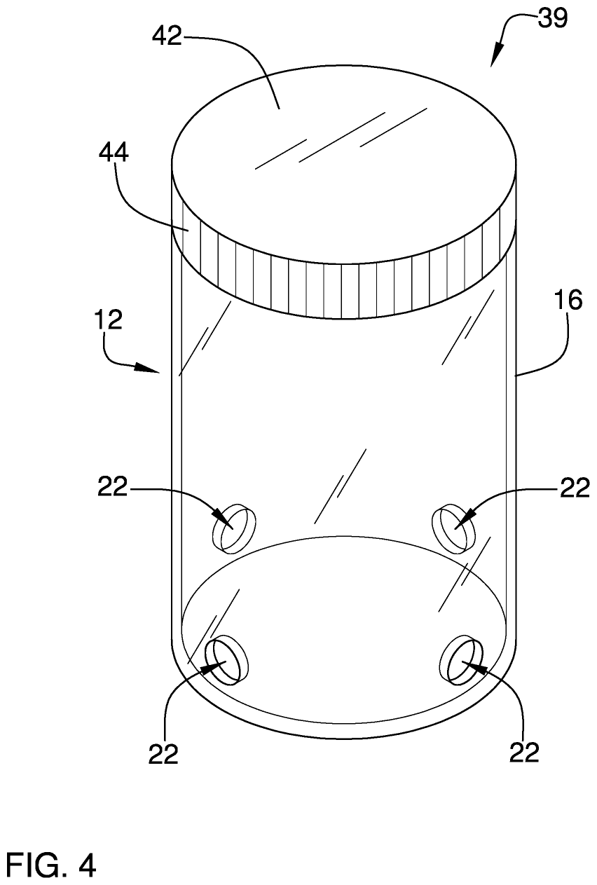

The outer wall 16 has an outer surface 36 and the outer surface 36 associated with the second portion 34 is threaded. The plurality of feed holes 22 extend through the outer surface 36 and an inner surface 38 of the outer wall 16 corresponding to the first portion 32 of the outer wall 16. Each of the plurality of feed holes 22 is positioned closer to the lateral wall 24 than the second portion 34 of the outer wall 16. Additionally, the feed holes 22 are evenly spaced apart from each other and are distributed around a full circumference of the outer wall 16. As is most clearly shown in FIGS. 1 through 3, the plurality of feed holes 22 may include two feed holes 22 that are positioned on opposite sides of the outer wall 16 from each other. In an alternative embodiment 39 as is most clearly shown in FIG. 4, the plurality of feed holes 22 may include four feed holes 22 that are distributed around the outer wall 16.

A lid 40 is included that is removably attachable to the feed container 12 for closing the feed container 12 and for retaining the granular animal feed 14 in the feed container 12. The lid 40 has a sidelong wall 42 and an exterior wall 44 extending away from the sidelong wall 42. The exterior wall 44 is continuously arcuate about a center point of the sidelong wall 42 and the exterior wall 44 has an interior surface 46. The interior surface 46 is threaded and the interior surface 46 threadably engages the outer surface 36 associated with the second portion 34 of the outer wall 16 of the feed container 12 for retaining the lid 40 on the feed container 12. The sidelong wall 42 rests against the distal edge 28 of the outer wall 16 of the feed container 12 having a distal edge 48 of the exterior wall 44 of the lid 40 abutting a shoulder 50 between the first portion 32 and the second portion 34 of the outer wall 16 of the when the lid 40 is threaded onto the feed container 12.

In use, a preferred volume of the granular animal feed 14 is poured into the feed container 12 and the lid 40 is tightened onto the feed container 12 to close the feed container 12. The feed container 12 is placed on a game trail thereby facilitating the feed container 12 to be accessible to a game animal 20. The game animal 20 will kick the feed container 12 with their feet or hooves 52 and roll the feed container 12 with their nose 54 like a toy. Additionally, the granular animal feed 14 will be released through the feed holes 22 as the feed container 12 is rolled along the ground 18. In this way the game animal 20 will be enticed to remain in the area thereby facilitating the game animal 20 to be harvested during hunting season.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. A game feeder assembly for feeding game in their natural habitat to facilitate a hunter to track the game more efficiently, said assembly comprising:
a feed container for containing a granular animal feed, said feed container having an outer wall being continuously arcuate about a center line of said feed container wherein said feed container is configured to be rolled along the ground by an animal, said feed container having a plurality of feed holes each extending through said outer wall thereby facilitating each of said feed holes to release said granular animal feed through said plurality of feed holes wherein said plurality of feed holes is configured to release the granular animal feed when said feed container is rolled along the ground thereby enticing the animal to remain with said feed container;
wherein said feed container has a lateral wall, said outer wall extending away from a perimeter edge of said lateral wall, said outer wall being continuously arcuate about a center point of said lateral wall such that said feed container has a cylindrical shape wherein said feed container is configured to roll on the ground about an axis extending between said lateral wall and a distal edge of said outer wall, said distal edge of said outer wall defining an entrance into said feed container for filling said feed container with said granular animal feed;
wherein said outer wall has a first portion intersecting said lateral wall and a second portion being inset with respect to said first portion, said second portion being associated with said distal edge such that said entrance defined by said distal edge has a diameter being less than a diameter defined by said first portion of said outer wall, said outer wall has an outer surface, said outer surface associated with said second portion being threaded; and
a lid being removably attachable to said feed container for closing said feed container and retaining said granular animal feed in said feed container, said lid having a sidelong wall and an exterior wall extending away from said sidelong wall, said exterior wall being continuously arcuate about a center point of said sidelong wall, an outer diameter of said exterior wall being equal to an outer diameter of said first portion of said outer wall.

2. (canceled)

3. (canceled)

4. The assembly according to claim 1, wherein said plurality of feed holes extends through said outer surface and an inner surface of said outer wall corresponding to said first portion of said outer wall, each of said plurality of feed holes being positioned closer to said lateral wall than said second portion of said outer wall, said plurality of feed holes being evenly spaced apart from each other and being distributed around a full circumference of said outer wall.

5. The assembly according to claim 1, wherein said exterior wall has an interior surface, said interior surface being threaded, said interior surface threadably engaging said outer surface associated with said second portion of said outer wall of said feed container for retaining said lid on said feed container, said sidelong wall resting against said distal edge of said outer wall of said feed container having a distal edge of said exterior wall of said lid abutting a shoulder between said first portion and said second portion of said outer wall of said when said lid is threaded onto said feed container.

6. A game feeder assembly for feeding game in their natural habitat to facilitate a hunter to track the game more efficiently, said assembly comprising:
a feed container for containing a granular animal feed, said feed container having an outer wall being continuously arcuate about a center line of said feed container wherein said feed container is configured to be rolled along the ground by an animal, said feed container having a plurality of feed holes each extending through said outer wall thereby facilitating each of said feed holes to release said granular animal feed through said plurality of feed holes wherein said plurality of feed holes is configured to release the granular animal feed when said feed container is rolled along the ground thereby enticing the animal to remain with said feed container, said feed container having a lateral wall, said outer wall extending away from a perimeter edge of said lateral wall, said outer wall being continuously arcuate about a center point of said lateral wall such that said feed container has a cylindrical shape wherein said feed container is configured to roll on the ground about an axis extending between said lateral wall and a distal edge of said outer wall, said distal edge of said outer wall defining an entrance into said feed container for filling said feed container with said granular animal feed, said outer wall having a first portion intersecting said lateral wall and a second portion being inset with respect to said first portion, said second portion being associated with said distal edge such that said entrance defined by said distal edge has a diameter being less than a diameter defined by said first portion of said outer wall, said outer wall having an outer surface, said outer surface associated with said second portion being threaded, said plurality of feed holes extending through said outer surface and an inner surface of said outer wall corresponding to said first portion of said outer wall, each of said plurality of feed holes being positioned closer to said lateral wall than said second portion of said outer wall, said plurality of feed holes being evenly spaced apart from each other and being distributed around a full circumference of said outer wall; and
a lid being removably attachable to said feed container for closing said feed container and retaining said granular animal feed in said feed container, said lid having a sidelong wall and an exterior wall extending away from said sidelong wall, said exterior wall being continuously arcuate about a center point of said sidelong wall, an outer diameter of said exterior wall being equal to an outer diameter of said first portion of said outer wall, said exterior wall having an interior surface, said interior surface being threaded, said interior surface threadably engaging said outer surface associated with said second portion of said outer wall of said feed container for retaining said lid on said feed container, said sidelong wall resting against said distal edge of said outer wall of said feed container having a distal edge of said exterior wall of said lid abutting a shoulder between said first portion and said second portion of said outer wall of said when said lid is threaded onto said feed container.

7. A method for feeding game on a game trail, the steps of the method comprising:
pouring a granular animal feed into a feed container such that said feed container is partially filled with said granular animal feed, said feed container having an outer wall being continuously arcuate about a center line of said feed container wherein said feed container is configured to be rolled along the ground, said feed container having a plurality of feed openings each extending through said outer wall such that each of said feed openings releases said granular animal feed when said feed container is rolled;
threading a lid onto said feed container for closing said feed container; and
placing said feed container on a game trail wherein said feed container is configured to be rolled along the ground by a game animal thereby facilitating said granular animal feed to be released from said plurality of feed openings for enticing the game animal to remain with said feed container.
